(19) United States
(12) Patent Application Publication
(10) Pub. No.: US 2026/0266581 A1
(43) Pub. Date: Sep. 10, 2026

(54) ARCHERY BOW SIGHT LIGHT

(71) Applicant: H.I.T. Outdoors, LLC, Clay City, KY (US)

(72) Inventor: Brian K. Jones, Clay City, KY (US)

(21) Appl. No.: 19/074,911

(22) Filed: Mar. 10, 2025

(51) Int. Cl. F41G 1/467; F21L 4/04; F21L 4/08; F21V 21/096; F21V 33/00; F41G 1/34; F41G 1/42

(52) U.S. Cl. CPC F41G 1/467; F21L 4/04; F21L 4/08; F21V 21/0965; F21V 33/008; F41G 1/345; F41G 1/42; F21V 2200/10

(57) ABSTRACT

An archery bow sight can include a sight housing and a light assembly rotatably mounted to the sight housing, the light assembly including a light source reconfigurable in multiple orientations relative to the sight housing to project illumination in different directions thereby illuminating a sight pin of the bow sight. The light assembly can removably mount to a sight housing rim via a magnetic force, thereby securing the light assembly relative to the sight housing in various ones of the multiple orientations. The light assembly can include a ring with a first array of magnets on the housing and a second array on the ring. The ring can be rotatably mounted to the housing, with the first array moving relative to the second array and securing the components. The sight can include a second light assembly magnetically mountable to the housing to replace the first light assembly.

### BACKGROUND OF THE INVENTION

The present invention relates to archery, and more particularly to an archery bow sight light.

Archery has been part of human culture for thousands of years and continues to be a popular sport and recreational activity. The precision required in modern archery is aided significantly by various types of equipment designed to enhance the accuracy of the archer's shot. One component of this equipment is the bow sight, which is mounted on the bow to help the archer align their shot accurately. A bow sight typically includes multiple sight pins, which an archer will adjust and sight in for desired shot placement on an intended target. The sight pins help the archer judge where the arrow will land based on the pin corresponding to an estimated distance. The positioning of these sight pins is critical for accuracy, and they must be clearly visible to the archer, especially in varying light conditions.

A common problem faced by archers in low-light conditions such as dawn, dusk, or when shooting indoors with poor lighting, is the visibility of the sight pins. To address this issue, many modern bow sights are equipped with lighting systems to illuminate the sight pins. These lighting systems often use small LED lights mounted on the sight itself to provide sufficient illumination. The increased visibility of the sight pins allows the archer to make more accurate shots even when the ambient light is insufficient.

However, there are limitations associated with fixed lighting solutions on bow sights. Typically, these systems include a light mounted in an exact, fixed position relative to the sight pins. Although they provide illumination, they also have several drawbacks. Fixed lights are often unable to adjust to varying environmental conditions such as different light levels, angles, or distances from the shooter. In many cases, the fixed light may either be too bright, causing glare and reducing clear viewing of the sight pins, or too dim, making the sight pins hard to see.

Moreover, the location and positioning of fixed lights are often less than ideal for different archers or shooting environments. The fixed position of the light source may illuminate certain sight pins more effectively while leaving others inadequately lit, making it challenging for the archer to achieve consistent accuracy. Additionally, fixed lighting systems may add unwanted weight or complexity to the sight, which can negatively affect the overall performance of the bow or the archer's ability to make quick adjustments during a shot.

Furthermore, when a fixed light is positioned too closely to the sight pins, it can lead to unwanted reflections or excessive light scatter, reducing the visibility of the sight pins instead of enhancing it. This creates a tradeoff where the lighting intended to improve visibility becomes a hindrance to accuracy, particularly in competitive or high-pressure environments.

Accordingly, there remains room for improvement in the field of systems for illuminating sight pins that overcome the limitations of conventional bow sight light solutions.

### SUMMARY OF THE INVENTION

An archery bow sight is provided and can include a sight housing and a light assembly rotatably mounted to the sight housing, the light assembly including a light source reconfigurable in multiple orientations relative to the sight housing to project illumination in different directions thereby illuminating a sight pin of the bow sight.

In one embodiment, the light assembly can removably mount to a sight housing rim via a magnetic force, thereby securing the light assembly relative to the sight housing. The magnetic force can be modifiable to allow the light assembly to move to various ones of the multiple orientations.

In another embodiment, the light assembly can include a ring that mounts to the sight housing rim. The ring can be rotatable relative to the rim. The ring can be rotatable at least 90 degrees to reorient the light source from projecting illumination in a first direction to projecting the illumination in a second direction transverse to the first direction. The magnetic force can be modified or replaced with a second magnetic force to support the ring with the light source projecting the illumination in the second direction upon reorientation of the ring relative to the housing.

In still another embodiment, the sight housing can include a first array of magnets and the ring can include a second array of magnets. The ring can be rotatably mounted to the housing, with the first array moving relative to the second array upon overcoming a first magnetic force. When the ring realigns with the rim in a different orientation, a second magnetic force can secure the ring to the housing in another fixed orientation. The second orientation can correspond with the illumination directed in the second direction.

In yet another embodiment, a first magnetic element is fixed relative to the sight bousing, a second magnetic element is fixed relative to the light assembly, and a third magnetic element is fixed relative to the light assembly. The first magnetic element and the second magnetic element can provide the first magnetic force to removably join the first light assembly with the sight housing adjacent the housing outer rim so that the first light source projects light in the first direction. The first magnetic element and the third magnetic element can provide a second magnetic force to removably join the first light assembly with the sight housing adjacent the housing outer rim in another orientation so that the first light source projects light in the second direction.

In even another embodiment, the light assembly includes the ring. A fiber optic filament can extend from a sight pin and around the housing outer rim. The housing outer rim can define a rim groove. The fiber optic filament can be disposed in the rim groove. The first ring can cover and/or at least partially conceal the fiber optic filament in the rim groove.

In a further embodiment, the first light source can be aligned with the rim groove and the fiber optic filament therein. That first light source can remain aligned with and can overlap the rim groove during a transition mode as the ring is rotated about the longitudinal axis to align the light source differently about the outer rim of the sight housing.

In still a further embodiment, the sight can include a second light assembly magnetically mountable to the housing to replace the first light assembly. The second light assembly can include a second light source, a second power source, a controller, a timer, a manual input interface and/or a display.

In yet a further embodiment, the second light assembly can include another magnetic element and a second ring. The second ring can be positioned adjacent the housing outer rim after the first ring and first light assembly are removed from the sight housing. The magnetic element of the second light assembly can exert a magnetic force on the first magnetic element of the sight housing to secure the second light assembly to the sight housing.

In even a further embodiment, the second light assembly can also be reoriented to change a direction of illumination by the second light source. The second light source can be moved around the housing outer rim to reorient the controller or other components of the second light assembly. The second magnetic element can be magnetically engaged with different magnetic elements of the sight housing to couple the second light assembly in the different orientation to achieve a particular illumination of the sight pin and/or a fiber optic filament associated with the sight pin.

In another embodiment, the first light assembly and second light assembly can come in a kit with the archery bow sight. A user can select which of the first and second light assemblies to join with the sight housing to illumination the sight pin. The user can install the selected assembly on the sight housing via a magnetic force. The user can reorient either of the sight assemblies about the rim and longitudinal axis of the sight housing by modifying the magnetic force and rotating or moving the light assembly.

In still another embodiment, the installed first or second light assembly can be removed and replaced with the other light assembly in a switching mode. In some cases, the first and second light assembly can be completely removed from the archery bow sight so that no illumination from either assembly is provided to illuminate or enhance illumination of the sight pin.

The current embodiments of the archery bow sight provide a simple and efficient light assembly to provide illumination for components of the bow sight, such as a sight pin. The light assembly can be magnetically joined with a sight housing and easily and quickly reoriented, uninstalled or reinstalled relative to the sight housing by a user.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of an archery bow sight including a first light assembly of a current embodiment installed in a first orientation relative to a sight housing.

FIG. 2 is a perspective view of the first light assembly displaced from the light housing.

FIG. 3 is a perspective view of the sight housing with an exposed housing outer rim defining a groove within which fiber optic filaments are disposed before a first ring of a first light assembly are installed relative to the housing outer rim.

FIG. 4 is a perspective view of the first light assembly reoriented relative to the sight housing in a second orientation.

FIG. 5 is a perspective view of the archery bow sight including a second light assembly installed in a first orientation relative to the sight housing of the archery bow sight.

FIG. 6 is a perspective view of the second light assembly displaced from the light housing.

FIG. 7 is a perspective view of the second light assembly being reoriented relative to the sight housing in a second orientation.

### DETAILED DESCRIPTION OF THE CURRENT EMBODIMENTS

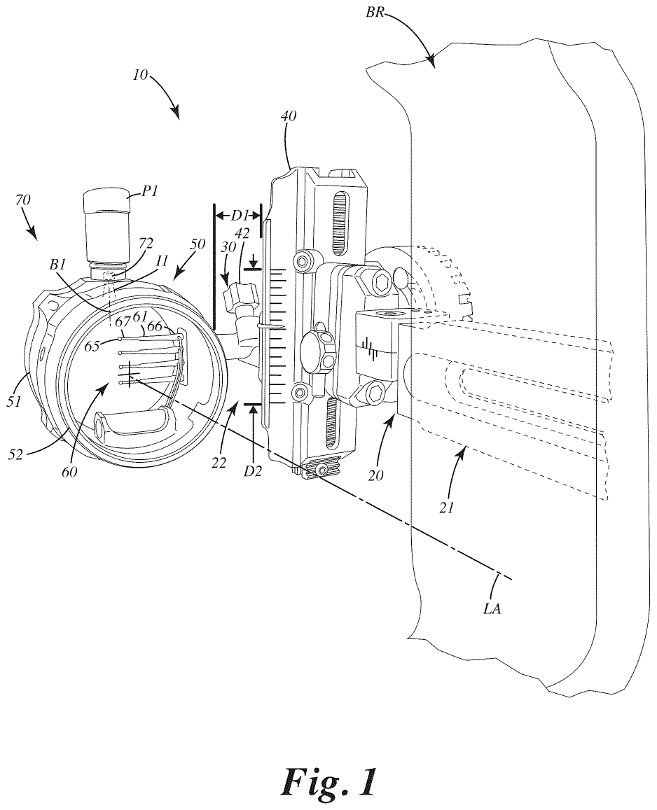

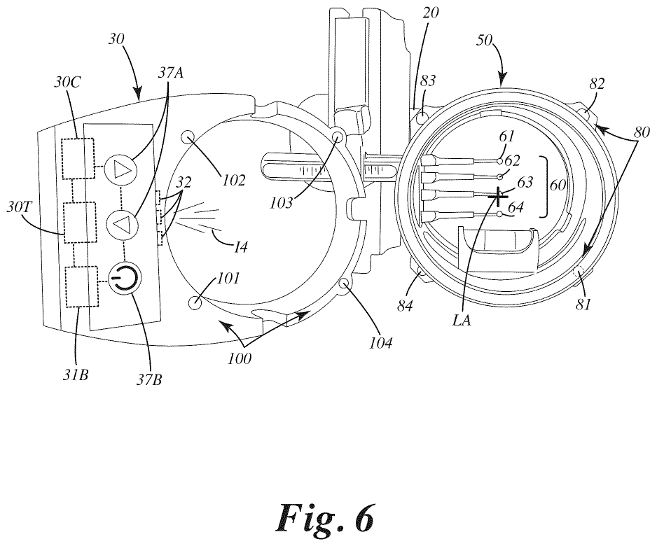

An archery bow sight constructed in accordance with an embodiment of the invention is illustrated in FIGS. 1-7 and generally designated 10. The sight 10 can include a mounting bracket 20, an elevation adjuster 41, a windage adjuster 42, a sight housing 50, one or more sight pins 60 in the sight housing, a first light assembly 70 and/or a second light assembly 30. The mounting bracket 20 can have one or more holes, or can be of a particular shape, to be fastened or otherwise secured to a riser BR of an archery bow. For purposes of this disclosure, the bow sight is described in connection with its use on an archery bow, however, the construction is well suited for use with any projectile shooting device. Optionally, the mounting bracket can be an elongated bar configured for insertion into part of a riser and securement thereto with a clamp or other fastening mechanism.

The mounting bracket 20 can include a proximal end 21 that joins with an archery bow riser BR and a distal end 22 that projects forwardly of the proximal end and is configured to extend forwardly of an archery bow riser when the bow sight 10 is mounted to the bow riser. The sight can include an elevation adjuster 41 and/or a windage adjuster 42 joined with or adjacent the distal end 22 of the mounting bracket 20, generally between the mounting bracket and the sight housing 50. The windage adjuster 42 can be configured to adjust the side to side or lateral distance D1 of the sight housing 50 from the bracket 20 and generally from some portion of the archery bow to which the sight 10 is connected. The elevation adjuster can be configured to adjust the sight housing up and down within the vertical distance D2 to provide elevation and ranging adjustments to the sight. The vertical adjuster 41 can move the windage adjuster 42 up or down. Although a particular vertical adjuster 41 and windage adjuster 42 are shown, other types of adjusters can be substituted for use with the current sight 10. Further, although not shown, the vertical adjuster can be provided in the sight housing 50 to move the respective sight indicia 60. Further optionally, the vertical adjuster and/or the windage adjuster can be absent from the sight.

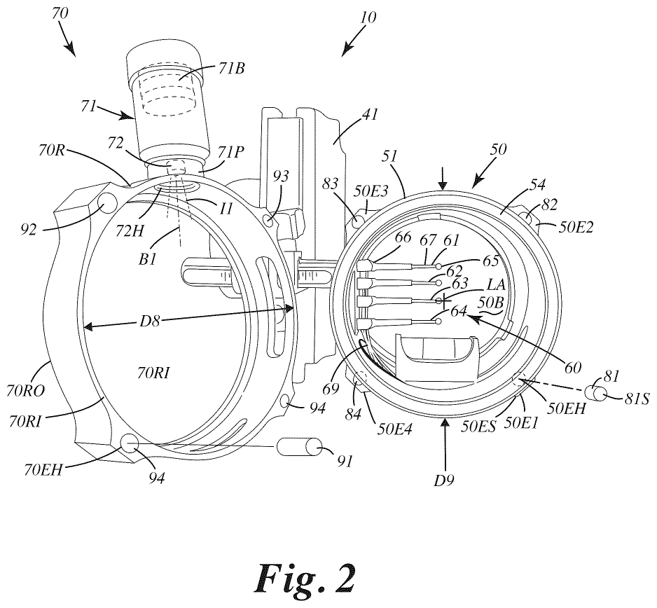

The sight housing 50 can be a rigid element that protects and/or surrounds one or more sight pins 60, which as shown, can include four sight pins 61, 62, 63, 64 corresponding to four different ranges. Additional or fewer sight pins can be included in the sight housing and the number can vary, depending on the number of ranges that the bow sight is to accommodate. As shown in FIG. 2, each sight pin 60, for example pin 61 can include a first end 66, which is proximal to a wall of the sight housing. Although referred to as “pins”, a sight pin can be of any cross section, for example, circular, rectangular, triangular, elliptical and the like, and can be of variable cross sections along their lengths. The sight pin 61 can also include a second end 67, distal from the first end, which can include a sight indicia 65. This sight indicia can be any point or indicia of any type that is visually placed in line with a target for assisting in the proper aiming of the bow. Sight indicia can be of any shape, for example, circular, diamond, square, and other geometrical shapes. Moreover, the sight indicia can be formed as colored dots, the end of a fiber optic filament, or simply the end of the sight pin. As shown, however, the sight indicia can be formed by the ends of fiber optic filaments, which collect light along the length of the fiber optic filaments, with the collected light exiting the end of the filament. The length of the fiber optic filament can be secured in a conventional manner to the sight element. The end of the fiber optic filament forming the sight indicia can be located in a hole defined in the second end 67 of the sight pin. Alternatively, the hole may be absent, and the fiber optic filament can be adhered or crimped or otherwise fastened to the second end as desired. Further optionally, the fiber optic filament can be replaced entirely with a vile, bulb or tube (not shown) containing a light emitting substance, such as tritium and/or phosphor. The tube can be secured in the hole much like the fiber optic filament to provide a sight indicia for an archer. Alternatively, the entire sight element can be constructed from light gathering and transmitting material. Yet further optionally, the sight pin can be vertically adjustable within the sight housing using any conventional mechanism.

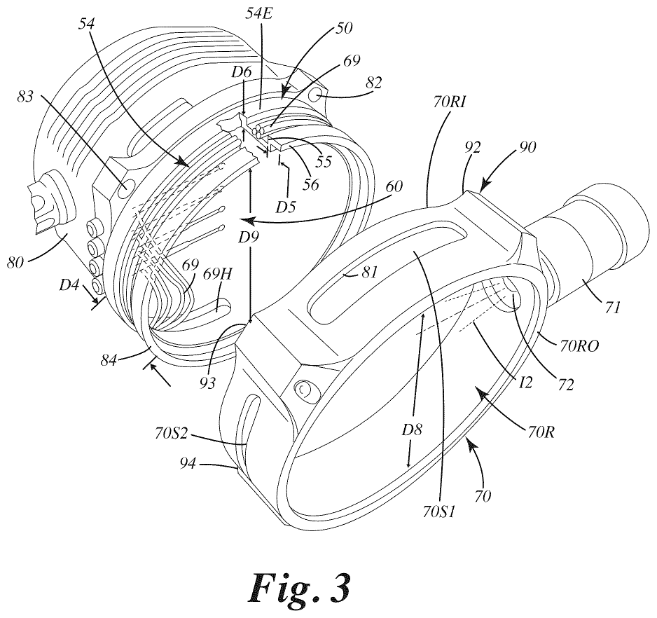

As shown, in FIGS. 2 and 3, the fiber optic filaments 69 can extend from one or more of the sight pins 60 and can extend through a hole 69H defined by the sight housing 50. The sight housing 50 can be in the form of a cylindrical or tubular shape. The fiber optic filaments 69 can wrap around the rim, generally following the shape of the housing, and in some cases can wrap entirely around the rim one, two or more times. The sight housing can be connected to the windage adjuster 42, elevation adjuster 41 and/or the mounting bracket 20 and movable with the various components thereof for elevation and/or windage. The sight housing 50 can include an internal bore 50B within which the sight pins 60 can be disposed. The sight housing can include a housing outer rim 54. This rim can be disposed at the forward portion or first end 51 of the sight housing 50 and/or optionally at the rearward portion or second end 52 of the housing 50 which faces generally toward a user of the sight 10. The sight housing can define a longitudinal axis LA that generally extends through a center or other portion of the sight. A user can generally view the pins 60 along the longitudinal axis or at some angle relative thereto when sighting with the sight 10. The sight housing outer rim 54 optionally can extend forwardly a distance D4 from a shoulder 54S that extends outwardly from the outer surface of the sight housing 50. The outer rim optionally can be substantially round, circular or of a cylindrical shape having a depth D4 and surrounding the longitudinal axis LA of the sight housing. This depth D4 can be equal to or less than a thickness of the first ring 70R of the first light assembly 70 as described below. The sight housing outer rim alternatively can be of a polygonal, elliptical or other shape including multiple angles and or facets, depending on the application.

With reference to FIG. 3, the sight housing outer rim 54 can define a rim groove 55, optionally rearward of a forward edge 56 of the housing outer rim 54. This rim groove can be disposed rearward a distance D5 from the forwardmost edge 56 of the rim 54. The groove 55 can be of a depth D6 sufficient to enable the one or more fiber optic filaments 69 to fit within the groove without protruding above or out of the groove and beyond the exterior surface 54E of the outer rim 54. Thus, the fiber optic filaments can be disposed within the groove and protected therein from inadvertent snagging, marring or breaking. As used herein, a fiber optic element can include a fiber optic filament, a fiber optic light pipe, a plastic optical fiber, a graded index fiber, a step index fiber, a bend-insensitive fiber, a photonic crystal fiber, a hollow core fiber, a tapered fiber optic, or other light transmissive elongated elements, ribbons and the like. As described below, the outer rim and generally the sight housing can be configured to receive and/or interface with the first light assembly 70. In this interface, a light source 72 of a light unit 71 associated with the first light assembly 70 can project illumination in various directions toward the fiber optic filaments, generally around the longitudinal axis LA as the light assembly is moved to different positions described below.

The sight housing 50 can include one or more first magnetic elements 80 that can be fixed relative to the sight housing. These first magnetic elements can be magnetically attracted to or by one or more second magnetic elements 90 that can be fixed relative to the light assembly 70. As used herein a magnetic element can be a magnet and/or an iron containing feature that is attracted to or by a magnetic force. A magnetic element can refer to and/or include neodymium magnets, samarium cobalt magnets, alnico magnets, ferrite magnets and the like, and can be in the form or shape of pin magnets, bar magnets, ring magnets, disc magnets, button magnets, coin magnets and the like.

With reference to FIG. 2, the sight housing 50 can include one or more ears, tabs or protrusions 50E1, 50E2, 50E3, 50E4 around an exterior surface of the sight housing. These ears or tabs can be disposed adjacent to shoulder 54S near the outer rim 54 of the sight housing 50. These protrusions can include one or more of the first magnetic elements. For example, the protrusion 50E1 can include a first magnet 81, the protrusion 50E2 can include a second magnet 82, the protrusion 50E3 can include a third magnet 83, and the fourth protrusion 50E4 can include a fourth magnet 84. In the example shown in FIG. 2, the first magnet 81 (as well as the other magnets) can be a button or pin neodymium magnet. That magnet can be disposed in a recess or hole 50EH defined by the protrusion 50E1. The magnet 81 can be pressed fit, glued, fastened, welded or otherwise secured in the hole or bore 50EH to retain it within the protrusion. Generally, the outer surface 81S of the first magnet 81 can be flush with the surface 50ES of the protrusion, which surface 50ES can be flush or continuous with the shoulder 54S around the rim 54. Of course in other applications, these components can be offset from one another.

With further reference to FIG. 2, the first magnetic element, which can comprise one or more of the magnets 81, 82 and 83 and 84 can be constructed so that the magnets are disposed around the longitudinal axis LA. Optionally, each magnet can be offset from the next by about 90°. Of course, where more magnets are included, the respective magnets can be offset from one another by different degrees, for example, 30°, 45°, 60°, 120°, 180° or by other angles. In some cases, only one magnet may be included on the housing which can engage the second magnetic element 90 of the first light assembly 70.

As mentioned above, the sight 10 can include a first light assembly 70. This first light assembly can include a light unit 71 and a light source 72 within the light unit 71. The light unit 71 can be threaded into a threaded aperture 72H of a first ring 70R. The light unit 71 can include a threaded post 71P that threads into that threaded aperture 71H. The light unit 71 can include a power source 71B therein to power the light source 72 within the light unit. The power source can be a battery, a solar cell, a tritium or phosphorus element associated with the light source or other type of element configured to emit illumination I2 therefrom and generally toward a longitudinal axis LA of the sight housing and/or the sight pins 60 when the first light assembly 70 is installed relative to the sight housing 50.

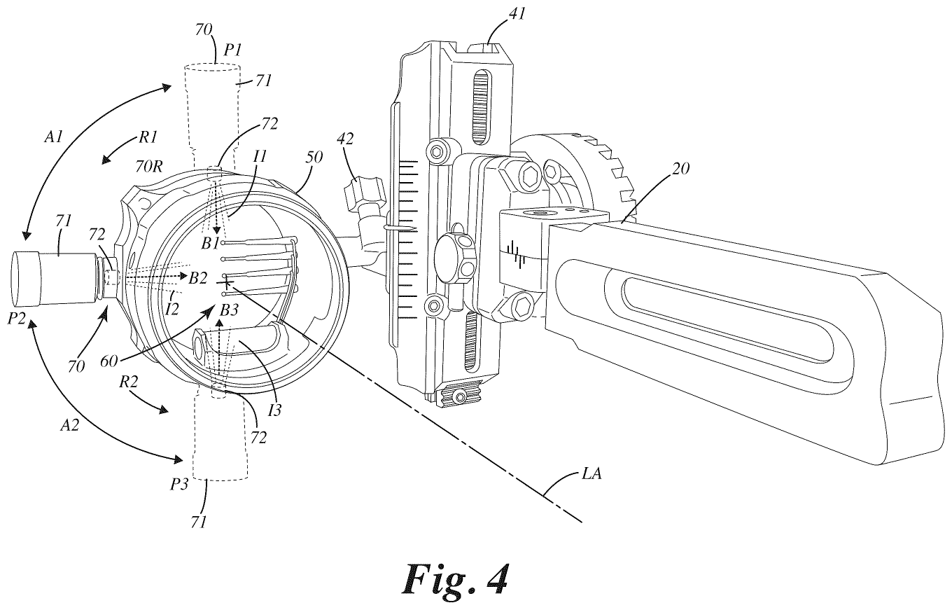

The first light assembly 70 can be generally removably joined with the sight housing, optionally along the housing outer rim 54. For example, the first ring 70R can have a diameter D8 that is greater than a diameter D9 of the outer rim 54. The first ring 70R thus can fit over the outer rim. The ring can include an inner edge 70RI in an outer edge 70RO. The inner edge 70RI can abut against the shoulder 54S when the first ring 70R is disposed and installed relative to the sight housing 50. The first ring 70R can be configured so that it allows the light source 72 to project illumination on or toward the fiber optic filament 69 along the outer rim 54 of the sight housing. The illumination I2, for example as shown in FIGS. 3 and 4 can project directly onto the fiber optic filaments 69 disposed in the groove 55. These fiber optic elements thus can transfer light to the respective sight pins 60 and illuminate the sight indicia at those sight pins for a user to view and see clearly.

Optionally, although shown as projecting illumination directly on to the fiber optic elements 69 that wrap around the outer rim and within the groove 55, the housing may alternatively include apertures, holes, slots or the like around the rim so that the illumination I2 from the light source 72 of the first light assembly 70 can be projected directly onto the sight pins 60 themselves or components of those sight pins to illuminate them. Further optionally, the ring 70R as shown in FIG. 3 can define one or more slots 71S1, 70S2 or other apertures that allow ambient light to reach the fiber optic filaments 69 around the outer rim 54 of the sight housing 50, with the light source 72 powered on or off depending on the application and the user's preference.

The first ring 70R can include a round or circular shape which corresponds to the round or circular shape of the outer rim 54. Thus, the first ring 70R can rotate about the housing outer rim in the embodiment shown. In alternative embodiments, where the ring and rim are of different shapes, rotation might not be possible, so the ring can be removed, rotated then replaced relative to the housing to change orientation of the first light assembly. As shown in FIG. 4, the first light assembly 70 is translatable about the longitudinal axis LA to reorient the light unit 71 and the light source 72 to project illumination in different directions, generally along different paths. For example, when the light unit 71 and the light source 72 are at position P1, the light source 72 can project illumination I1 in a first direction B1, which can be directly toward the fiber optic filaments 69 and the outer rim 54. The first light source 72 in this orientation can direct light along the path or first direction B1 that is generally toward the longitudinal axis LA.

As mentioned above, the first light assembly 70 is translatable about the longitudinal axis LA to reorient the first light source 72 and the light unit from the first position P1 to a second position P2. This can be accomplished by rotating the light unit 71 in direction R1 and through an angle A1. Optionally this angle can be about 90°, but can be other angles, such as 30°, 45°, 60°, 120°, 180° depending on the suitable amount of reorientation and an intended direction of illumination. After the light unit and light source moves through the angle A1, it assumes a new position P2. Due to the magnetic forces holding the light assembly in the second fixed position P2, the light source 72 can be fixed and stationary relative to the housing and can project the illumination I2 in a second direction B2. The second direction B2 can be transverse to the previous direction B1 when the light unit and light source were in the position P1. Optionally, the second direction B2 in which the illumination I2 is projected can be 90° offset from the first direction B1. Of course, other angles such as 30°, 45°, 60°, 120°, 180° can be selected for the offset of the direction B2 from direction B1.

Further optionally, because the first light assembly 70 is translatable about the longitudinal axis LA, the first ring 70R can be yet further translated such that the light unit 71 and the light source 72 are moved to a third position P3, which can extend generally downward from the sight housing 50, rather than laterally outward from the sight housing in position P2 or generally vertically upward from the sight housing in position P1. The light unit 71 and first light source 72 can be rotated in direction R2, through an angle A2 which can be similar to the angle A1 mentioned above. In this reoriented position P3, the first light source 72 can project illumination I3 in a third direction B3, generally upward and toward the longitudinal axis LA, and toward the fiber optic filaments 69 that are disposed about the outer rim 54. Optionally, in constructions where the outer rim 54 includes slots or holes, the illumination I3 can alternatively be directed directly toward the sight pins 60 within the housing. This third direction B3 of the illumination I3 can be transverse to the second direction B2 an optionally parallel but in an opposite direction from the first direction B1 mentioned above.

Optionally, with the first light assembly 70 translatable and as shown rotatable about the longitudinal axis LA, a user can move the light unit 71 that projects outwardly from the ring 70R to a preferred location, minimizing obstruction of an arow path or generally being in an out of the way location suitable for the user. It also will be appreciated that as the light source 72 is moved around the outer rim, it can illuminate different portions of the fiber optic filaments 69 as they extend around that rim within the groove. Accordingly, different ones of the individual sight pins 61, 62, 63, 64 may be illuminated more or less depending on the position of the first light source around the longitudinal axis projecting illumination on different parts of the fiber optic elements. For example, in some cases, placement of the light source in position P1 can cause the upper pin 61 to be illuminated more than the lower pin 64. As another example, placing the light source 72 in the position P2 can illuminate all of the pins 61-64 evenly. As yet another example, placing the light source 72 in the position P3 can illuminate the middle section pins 62 and 63 more than the other pins period. Depending on the position of the fiber optic elements within the groove and relative to the sight pins, these degrees of illumination can change depending on the position and can be fine-tuned for certain applications by ending the fiber optic filaments in particular locations around the outer rim, within the groove, so that the light source might not illuminate some of the filaments of some of the sight pins.

Generally, a user can cause the fiber optic filaments to selectively illuminate the respective sight pins and indicia in a customized manner according to a user's preference with the illumination. This can be achieved by moving the first ring 70R around the longitudinal axis to a particular position. The first light source can be reoriented around the longitudinal axis when the first light assembly 70 is reoriented around that longitudinal axis LA.

As mentioned above, the sight housing 50 can include a first magnetic element 80, which optionally can be in the form of one or more magnets 81, 82, 83, 84 disposed round the longitudinal axis LA and generally adjacent the outer housing rim 54. These magnets can interact with corresponding a corresponding second magnetic element 90 associated with the first light assembly 70. This second magnetic element 90 can be in the form of one or more magnets 91, 92 93 and 94. Each of these respective magnets can be disposed in the first ring 70R of the light assembly. As an example, the first magnet 91 can be optionally disposed in respective bores or apertures such as the hole 70EH defined by a protrusion 70E1 that is associated with the first ring 70R. The other magnets can include similar and can be disposed in similar bores within similar projections around the first ring 70R. These projections can be aesthetically similar to and can be flush with the projections on the sight housing so that they align with one another when the first ring 70R is installed on the housing outer rim 54 and relative to the sight housing 50. The magnets ring 91, 92, 93 and 94 of the second magnetic element can generally align with and magnetically attract to the corresponding housing magnets 81, 82, 83 and 84 when the first ring is aligned in the configuration shown with the light unit 71 or light source 72 in the position P1 in FIG. 4. The magnets 91, 92, 93 and 94 can generally be referred to as ring magnets, whereas the magnets 81, 82, 83 and 84 associated with the housing can generally be referred to as housing magnets.

When the first light assembly 70 is rotated by a user, for example, in direction R1, the first magnetic force between corresponding magnets, for example, first housing magnet 81 and the first ring magnet 91 is overcome. A user can exert sufficient force so that these magnetic forces are no longer engaging the ring with the rim to hold the first light assembly in the position shown as P1 in FIG. 4. The user can continue to rotate the light source 72 and generally the first light assembly 70 in the direction R1. Eventually, the first ring magnet 91 will near and become adjacent the fourth housing magnet 84. When this occurs, the first ring magnet 91 and the fourth housing magnet 84 are magnetically attracted to one another via a second magnetic force. The second magnetic force can be replicated via the other ring magnets being placed adjacent corresponding housing magnets around the housing. This can exert a second magnetic force to hold the first light assembly 70 and ring 70R relative to the sight housing at the outer housing rim, thereby holding the first ring in the second fixed position P2 relative to the sight housing as shown in FIG. 4.

If a user desires to change the orientation of the light unit 71 and/or light source 72 from the position P2 to P3, the user can again overcome the magnetic forces exerted between the ring magnets 91-94 and the corresponding housing magnets 81-84 to rotate the light source 72 and ring 70R in direction R2 through the angle A2. When the light unit 71 and/or light source 72 achieves the position P3, the ring magnets are again realigned with different ones of the housing magnets. For example, the first ring magnet 91 can be aligned with the third housing magnet 83 and the two magnets can exert another magnetic force on one another. Of course, the other paired ones of the ring magnets and housing magnets can do the same. This can exert a third magnetic force to hold the first light assembly 70 and ring 70R relative to the sight housing at the outer housing rim, thereby holding the first ring in the third fixed position P3 relative to the sight housing.

Optionally, a user can rotate or translate the first ring 70R relative to the housing and outer rim 54 to a variety of different positions. For example, the user can translate the ring rotating it about the longitudinal axis LA so that the light unit and light source are in positions P1, P2, P3 or other positions about the longitudinal axis LA. The corresponding ring magnets 90 can align with and be magnetically attracted to the corresponding housing magnets 80 in each of these orientations of the light assembly and the first ring relative to the housing. The magnets can exert a corresponding magnetic force to hold the ring and thus the light assembly in a fixed position relative to the housing. During the translation, the various ring magnets 91, 92, 93, 94 also can be repositioned and can switch locations relative to each of the respective housing magnets 81, 82, 83, 84. Thus, the first ring magnet 91 may be aligned with the first housing magnet 81, the fourth housing magnet 84, the third housing magnet 83, and/or the second housing magnet 82. Likewise, the second ring magnet 92 can be aligned with the second housing magnet 82, the first housing magnet 81, the fourth housing magnet 84 and/or the third housing magnet 83. The third ring magnet 93 can be aligned with and magnetically attracted to the third housing magnet 83, the second housing magnet 82, the first housing magnet 81 or the fourth housing magnet 84. The fourth ring magnet 94 can be aligned with and magnetically attracted to the fourth housing magnet 84, the third housing magnet 83, the second housing magnet 82 and/or the first housing magnet 81.

During translation of the light assembly 70 relative to the sight housing 50, the first light source 72 can remain aligned with and can overlap the rim groove 55 and the corresponding fiber optic filaments 69 disposed therein. This can occur as the first ring is rotated about the longitudinal axis and moves relative to the outer rim to the positions P1, P2, P3 etc. Generally, the first light source 72 can maintain illumination of the fiber optic filaments and thus the corresponding sight pins 60 (in communication with the filaments) inside the housing bore during the translation. As mentioned above, the specific pins that are illuminated can change depending on the orientation of the first light source relative to the rim and the fiber optic filaments about the longitudinal axis, and when the illumination projected by the light source changes directions as mentioned above in connection with directions B1, B2 and B3, as well as any other directions that the illumination may be projected in.

As one example of how magnetic forces can shift and change during translation of the light assembly in the ring about the longitudinal axis, references made to FIGS. 1, 2 and 4. When the first light assembly 70 is in the position P1, the ring is adjacent the outer housing rim 54. The first light source 72 projects illumination I1 in direction B1, generally downward toward the longitudinal axis LA. The first magnetic element, for example, the first magnet 81 of the sight housing can be aligned with the first ring magnet 91 of the light assembly. These magnets can be fixed relative to the respective components. The first magnetic force between the first housing magnet 81 and the first ring magnet 91 can be overcome and the light assembly 70 can be rotated in direction R1 through an angle A1 to a second position P2. In that second position P2, the first magnetic element in the 81 and the third magnetic element 92, which can be the second ring magnet, can align with one another to exert a second magnetic force to removably join the first light assembly with the sight housing adjacent the housing outer rim so that the first light source 72 projects light in the second direction B2, generally toward the longitudinal axis LA. Of course, the other various ring magnets can undergo similar transitions and movement and align with other ones of the housing magnets in a similar manner. Optionally, the collective forces of all the magnets can provide different magnetic forces at each position of the light assembly and removably secure the light assembly to the housing via the respective magnetic force.

As mentioned above, the archery bow sight 10 can include a second light assembly 30 that can be substituted for the first late assembly 70. In some applications, the bow sight 10 can come in a kit form, including the first light assembly 70 and the second light assembly 30. A user can replace one of these light assemblies for the other, substituting a simple light assembly, such as the first light assembly 70 for a more user friendly and feature rich light assembly such as the second light assembly 30. Generally, the second light assembly 30 can include some similar features as the first light assembly for removable attachment to the sight housing. For example, the second light assembly 30 can include a second ring 30R. The second ring 30R can include an array of magnets 101, 102, 103, 104. These magnets can be magnetically attracted via another magnetic force to corresponding ones of the housing magnets 81, 82, 83, 84 in a manner similar to that of the magnets 91, 92, 93 and 94. The second light assembly magnets 101-104 can exert another magnetic force between the ring 30R and the sight housing 50, and in particular the housing magnets 81-84 to secure the second light assembly 30 to the sight housing 50, generally around the rim 54.

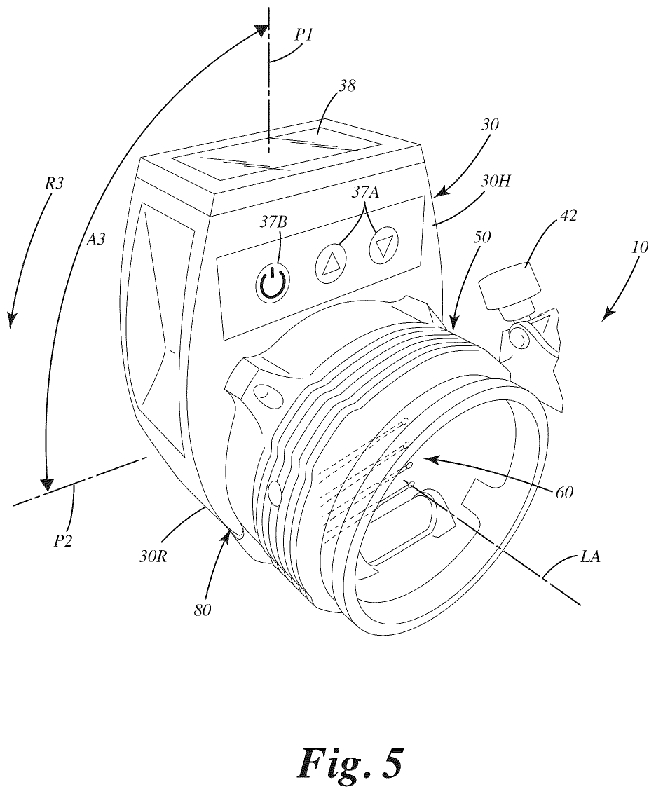

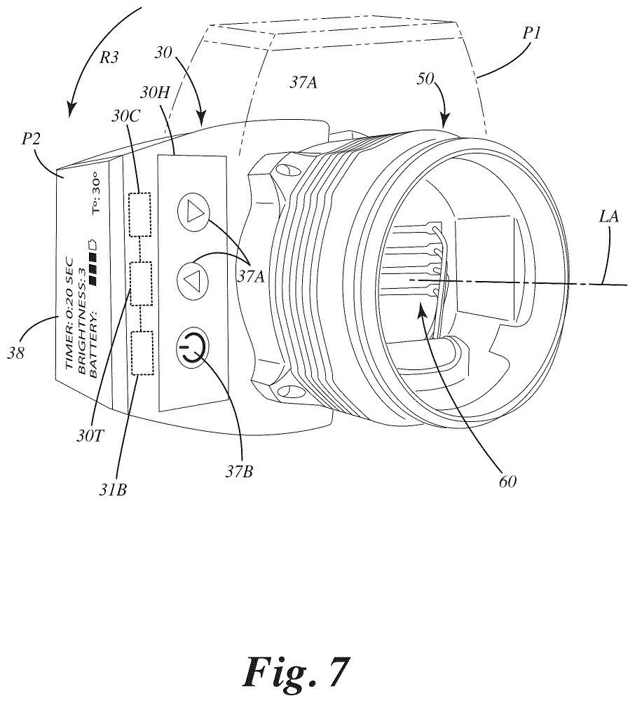

The first light assembly also can be translated and or moved or rotated about the longitudinal axis LA to orient the housing 30H of the light assembly in different orientations relative to the sight housing, depending on a user's preference. This also can reorient the second light source 32 of the second light assembly 30 in different orientations relative to the outer rim and the fiber optic filaments in the groove of the outer rim, as well as the longitudinal axis LA of the sight housing. For example, the housing 30H and the associated second light source 32 can be oriented in a first position P1 shown in FIG. 5. The housing can be held in this position fixed and stationary relative to the housing via the magnetic force exerted by the respective first magnetic elements 80 and the third magnetic elements 100, for example the ring magnets 101-104. A user can overcome the magnetic force, and rotate the housing 30H from the position P1 shown in FIG. 5 in direction R3 through an angle A1 to a second position P2 shown in FIG. 7. The angle A3 can be similar to the angle A1 described in connection with the first light assembly above. The housing and light source thus move and are reoriented such that the illumination projected by the light source 32 changes from a first direction to a second different direction that is transverse to the first direction. The housing and ring can be further translated or rotated to other orientations. When the respective housing magnets 81-84 align with respective ones of the ring magnets 101-104, the magnets can exert a sufficient magnetic force to hold the housing and the second light assembly in a fixed stationary position relative to the sight housing, similar to the way the first light assembly is held in a fixed stationary position relative to the sight housing as described above.

The second light assembly 30 as mentioned above can include more features than the first light assembly in some applications. For example, the second light assembly 30 can include a controller 30C, a timer 30T, and a power source 31B. The power source 31B can be in electrical communication with the second light source 32 to illuminate it, similar to the first light source described above. Likewise, the second light source can be aligned with the housing outer rim 54, the ring groove 55 as well as the fiber optic filament 69 in the ring groove or otherwise associated with the outer housing rim. As with the light source of the first light assembly above, the light source 32 of the second light assembly can be moved around the longitudinal axis LA and reoriented in multiple orientations to direct illumination from the light source in a first direction, a second direction, a third direction, etc.

The controller 30C can be in electrical communication with and can be operated via a user interface 37. This user interface can include a power on/off button 37B and one or more adjustment buttons 37A so the user can toggle through different features, parameters or operations for the controller of the second light assembly. The controller 30C optionally can be programmed and/or configured to turn off the light source 32 after a predetermined amount of time passes after the light source is powered by input from user through the manual input 37. The controller 37C can be programmed via the user using a display 38 to set the predetermined amount of time. For example, a user can use the manual input or buttons 37A to input a certain time increment, for example, 30 seconds, 1 minute, 2 minutes, 3 minutes, 4 minutes, 5 minutes, or other amounts of time after which to turn off the light source 32 and cease transmission of electricity or voltage from the battery 30B to the light source 32. The timer control 30T can start counting or measuring the time passage after the light source is initially powered on and the controller 30C starts to power the light source 32. After the first predetermined amount of time passes, the controller can cease power to the light source 32 and it can turn off, thereby ceasing illumination of the fiber optic filaments and the sight pins.

With reference to FIG. 7, the controller 30C can communicate with and/or control output on the display 38. The output can be in the form of alphanumeric characters. For example, as shown, the controller can output a timer and certain amounts of time that pass while the light source 32 is powered. The controller can display the brightness or intensity of illumination output by the light source 32 which can be controlled via the inputs 37A manually by a user for adjustment. The display 38 can show the remaining battery life, temperature, humidity or other environmental conditions. Further optionally, the controller can be linked to a user's personal device, such as a smartphone, to relay and communicate information output to the display 38 through the personal device. Yet further optionally, the battery 31B can be a replaceable, removable type of battery, such as a coin battery, however in other applications it can be a rechargeable battery with a charging port associated with the housing 30H of the second light assembly 30.

Further optionally, the controller can process different input from a user via the manual input buttons 37B, 37A. For example, the manual input can be configured so that the system is turned on upon the user pushing or engaging the manual input. The manual input can be configured so that the system turns completely off, when the manual input is pushed for more than 5 seconds. Again, the manual input can be configured to control the controller to alter the brightness of the display, the display of alphanumeric or other indicia on the display, such as battery life, a timer or clock, or some other output of the display 38 based on different sequences of engagement with the manual input. Although not shown, the manual input alternatively can be a one button toggle split in two or a two-button toggle that a user can operate to go through different settings of the second light assembly and illumination output by the second light source 32.

As mentioned above, the second light assembly 30 can be secured to the sight housing 50 via the ring magnets 100-104 exerting a magnetic force on or in combination with the housing magnets 81-84. To remove the second light assembly 30 from the sight housing 50, a user can overcome the magnetic force between the magnetic elements on the housing and assembly, thereby disassociating the ring 30R from the rim 54 such that the rim and the fiber optic elements are exposed to the environment. If desired, the user can reinstall the second light assembly 30 relative to the sight housing 50, or alternatively can install the first light assembly 70 relative to the sight housing 50. Again, the first and second light assemblies can be interchangeable with one another and easily switched and replaced one for the other by overcoming the magnetic forces between the rings of each assembly and the sight housing and replacing installing and/or removing the respective light assembly relative to the housing.

Although the different elements and assemblies of the embodiments are described herein as having certain functional characteristics, each element and/or its relation to other elements can be depicted or oriented in a variety of different aesthetic configurations, which support the ornamental and aesthetic aspects of the same. Simply because an apparatus, element or assembly of one or more of the elements is described herein as having a function does not mean its orientation, layout or configuration is not purely aesthetic and ornamental in nature.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Additionally, the features, structures, or characteristics of one embodiment are contemplated for proper and full combination in any suitable manner in one or more other embodiments, which is fully contemplated herein. Further, features, structures, or characteristics of one embodiment or multiple embodiments are readily and completely mixed and matched with any features, structures, or characteristics of any other embodiment or multiple embodiments in varying combinations and permutations.

What is claimed is:

1. An archery bow sight comprising:
a mounting bracket including a proximal end and a distal end, the proximal end configured to mount to an archery bow riser, the distal end projecting forwardly of the proximal end and configured to extend forwardly of the archery bow riser when the bow sight is mounted thereto;
at least one of a windage adjuster and an elevation adjuster joined with the distal end;
a sight housing joined with the distal end and moveable relative to the mounting bracket via at least one of the windage adjuster and the elevation adjuster, the sight housing including a longitudinal axis extending therethrough and a housing outer rim extending at least partially around the longitudinal axis;
a sight pin disposed in the sight housing adjacent the longitudinal axis and visible to a user;
a first light assembly comprising a battery and a first light source, the first light assembly removably joined with the sight housing along the housing outer rim;
a first magnetic element joined with the housing; and
a second magnet element joined with the first light assembly, the first magnetic element and the second magnetic element providing a first magnetic force to removably join the first light assembly with the sight housing adjacent the housing outer rim,
wherein the first light assembly is translatable about the longitudinal axis to reorient the first light source from projecting an illumination in a first direction to projecting the illumination in a second direction transverse to the first direction,
whereby the first light assembly is configured to be reoriented relative to the sight housing in a plurality of orientations to selectively illuminate the sight pin in a customized manner according to a user's preference with the illumination.

2. The archery bow sight of claim 1,
wherein the first light assembly includes a first ring,
wherein the first ring is disposed around the outer rim,
wherein the first light source is fixed relative to the first ring,
wherein the first light source is able to be reoriented about the longitudinal axis when the first light assembly is reoriented about the longitudinal axis.

3. The archery bow sight of claim 1,
wherein the first magnetic element is fixed relative to the sight housing,
wherein the second magnetic element is fixed relative to the light assembly,
wherein the light assembly includes a third magnetic element,
wherein the first magnetic element and the second magnetic element provide the first magnetic force to removably join the first light assembly with the sight housing adjacent the housing outer rim so that the first light source projects light in the first direction,
wherein the first magnetic element and the third magnetic element provide a second magnetic force to removably join the first light assembly with the sight housing adjacent the housing outer rim so that the first light source projects light in the second direction.

4. The archery bow sight of claim 1,
wherein the light assembly is operable in a transition mode in which the first ring is rotated about the longitudinal axis,
wherein in the transition mode, the first magnetic force is overcome and the second magnetic force is initiated,
whereby the first light assembly is reoriented from a first position about the housing outer rim to a second position about the housing outer rim.

5. The archery bow sight of claim 4,
wherein the first light assembly includes a first ring,
wherein a fiber optic filament extends from the sight pin and around the housing outer rim,
wherein the housing outer rim defines a rim groove,
wherein the fiber optic filament is disposed in the rim groove,
wherein the first ring covers the fiber optic filament in the rim groove.

6. The archery bow sight of claim 5,
wherein the first light source is aligned with the rim groove and the fiber optic filament therein,
wherein the first light source remains aligned with and overlaps the rim groove during the transition mode as the first ring is rotated about the longitudinal axis.

7. The archery bow sight of claim 1,
wherein the sight housing includes the first magnetic element which is a first housing magnet,
wherein the first sight housing includes a second housing magnet and a third housing magnet,
wherein the first light assembly includes a first ring that includes the second magnetic element which is a first ring magnet,
wherein the first ring includes a second ring magnet and a third ring magnet disposed about the longitudinal axis,
wherein the first ring magnet is urged toward the first housing magnet via the first magnetic force,
wherein the first light assembly is translatable about the longitudinal axis to reorient the first light source from projecting an illumination in a first direction, with the first ring magnet aligned with the first housing magnet to projecting the illumination in a second direction transverse to the first direction, with the first ring magnet aligned with the second housing magnet so that the first ring magnet is urged toward the second housing magnet to hold the first ring in a second fixed position relative to the sight housing.

8. The archery bow sight of claim 1,
wherein the first magnetic element is a first magnet joined with the first sight housing,
wherein the second magnetic element is a second magnet joined a first ring of the light assembly,
wherein the first ring includes a third magnet,
wherein the first magnet is urged toward the second magnet to secure the first ring in a first fixed orientation relative to the sight housing so the first light source projects the illumination in a first direction,
wherein the third magnet is urged toward the second magnet to secure the first ring in a second fixed orientation relative to the sight housing so the first light source projects the illumination in a second direction transverse to the first direction.

9. The archery bow sight of claim 8,
wherein the first ring includes a fourth magnet,
wherein the fourth magnet is urged toward the second magnet to secure the first ring in a third fixed orientation relative to the sight housing so the first light source projects the illumination in a third direction different from the first direction and the second direction.

10. The archery bow sight of claim 1, comprising:
a second light assembly including a second light source, the second light assembly configured to replace the first light assembly when the first magnetic force is overcome,
wherein the second light assembly includes a third magnetic element providing a second magnetic force to removably join the second light assembly with the sight housing adjacent the housing outer rim after the first light assembly is removed from the housing outer rim.

11. An archery bow sight comprising:
a mounting bracket configured to extend forwardly of an archery bow riser;
a sight housing joined with the mounting bracket, the sight housing including a longitudinal axis extending therethrough and a housing rim extending at least partially around the longitudinal axis;
a sight pin disposed in the sight housing adjacent the longitudinal axis and visible to a user; and
a first light assembly comprising a first light source, the first light assembly removably joined with the sight housing along the housing rim, the first light assembly translatable about the longitudinal axis to reorient the first light source from projecting an illumination in a first direction to projecting the illumination in a second direction transverse to the first direction,
wherein the first light assembly is magnetically mounted to the sight housing via a first magnetic force,
whereby the first light assembly is configured to be reoriented relative to the sight housing in a plurality of orientations to selectively illuminate the sight pin in a customized manner according to a user's preference with the illumination.

12. The archery bow sight of claim 11,
wherein the first light assembly includes a first ring,
wherein the first ring is rotatably mounted to the housing outer rim,
wherein the first ring is rotatable at least 90 degrees to reorient the first light source from projecting the illumination in the first direction to projecting the illumination in the second direction transverse to the first direction,
wherein the first magnetic force is replaced with a second magnetic force to support the first ring with the first light source projecting the illumination in the second direction.

13. The archery bow sight of claim 12,
wherein the first ring includes a plurality of ring magnets,
wherein the sight housing includes a plurality of housing magnets,
wherein the plurality of ring magnets move relative to the plurality of housing magnets about the longitudinal axis along an arc when reorienting the first light source.

14. The archery bow sight of claim 11,
wherein the first sight housing includes a first magnet adjacent the housing outer rim and a third magnet adjacent the housing outer rim distal from the first magnet,
wherein the first sight assembly includes a second magnet,
wherein the second magnet is magnetically urged toward the first magnet to secure the first light source relative to the sight housing so the first light source projects the illumination in the first direction,
wherein the second magnet is magnetically urged toward the third magnet to secure the first light source relative to the sight housing so the first light source projects the illumination in the second direction.

15. The archery bow sight of claim 11,
wherein the first light assembly includes a first ring that mounts to the housing outer rim,
wherein the first ring is rotatable at least 90 degrees about the housing outer rim,
wherein the light source is rotatably about the longitudinal axis at least 90 degrees with the first ring so that the first light source reorients from the first direction to the second direction.

16. The archery bow sight of claim 15 comprising:
a second light assembly with a second light source and a second ring that is mountable to the housing outer rim,
wherein the first light assembly is replaceable with the second light assembly to allow either the first light assembly or the second light assembly to be removably joined with the sight housing.

17. The archery bow sight of claim 16,
wherein the sight housing includes a first magnet,
wherein the first light assembly includes a second magnet,
wherein the second light assembly includes a third magnet,
wherein the first magnet and the second magnet magnetically join the first light assembly with the sight housing when the first light assembly is installed relative to the sight housing,
wherein the first magnet and the third magnet magnetically join the second light assembly with the sight housing when the second light assembly is installed relative to the sight housing.

18. An archery bow sight comprising:
a first light assembly including a first light source coupled to a power source, the first light assembly removably mountable to a rim of a sight housing via a magnetic force, the first light assembly translatable about a longitudinal axis to reorient the first light source from projecting an illumination in a first direction, to projecting the illumination in a second direction, the second direction transverse to the first direction,
wherein the first light assembly is configured to be reoriented relative to the sight housing in a plurality of orientations to selectively illuminate a sight pin in a customized manner according to a user's preference with the illumination.

19. The archery bow sight of claim 18,
wherein the first light assembly includes a first annular ring configured to fit over a groove defined in the rim and illuminate a fiber optic filament disposed in the groove.

20. The archery bow sight of claim 18,
wherein the first light assembly includes a first magnetic element,
wherein the sight housing includes a second magnetic element,
wherein the first magnetic element adjacent and magnetically urged toward the second magnetic element when the first light source projects the illumination in the first direction,
wherein the first magnetic element is distal from and not magnetically urged toward the second magnetic element when the first light source projects the illumination in the second direction.
